(19) United States
(12) Patent Application Publication
(10) Pub. No.: US 2015/0360650 A1
(43) Pub. Date: Dec. 17, 2015

(54) WIPER BLADE ASSEMBLY

(71) Applicant: Cap Corporation, Sangju-si (KR)

(72) Inventors: Myoung Yeon KIM, Ulsan (KR); Hyung Tae KIM, Incheon (KR)

(21) Appl. No.: 14/738,330

(22) Filed: Jun. 12, 2015

(30) Foreign Application Priority Data
Jun. 16, 2014 (KR) 10-2014-0072927

(51) Int. Cl. B60S 1/38

(52) U.S. Cl. CPC B60S 1/3801

(57) ABSTRACT

The present invention relates to a wiper blade assembly including: a primary lever; a secondary lever disposed to be adjacent to the primary lever; a secondary lever connecting structure coupled to the secondary lever; and a yoke member hinge-coupled to the secondary lever connecting structure, wherein the yoke member includes a claw portion, the claw portion being moved apart from the secondary lever and in the present invention, claw portions coupled to both ends of a contact member may be disposed in certain regions of yoke members and the yoke members may be moved apart from secondary levers, such that the claw portions may be moved apart from the secondary levers to allow for improvements in the property of following the curvature of glass, thereby wiping performance of a wiper.

### CROSS-REFERENCE TO RELATED APPLICATION

This application claims priority from Korean Patent Application No. 10-2014-0072927 filed on Jun. 16, 2014 in the Korean Intellectual Property Office, the disclosure of which is incorporated herein by reference in its entirety.

### BACKGROUND

1. Field of the Invention

The present invention relates to a wiper blade assembly, and more particularly, to a structure of a wiper blade assembly able to better follow the curvature of glass.

2. Description of the Related Art

A wiper blade assembly wipes rain or dirt from a vehicle's windshield to ensure the driver's view. The wiper blade assembly is connected to a wiper arm connected to a driving shaft which is connected to a wiper driving motor on the vehicle side. Thus, the wiper blade assembly is driven by the wiper arm.

The wiper arm and the wiper blade assembly are coupled to each other by a wiper connector. Generally, a member called a clamp is provided in the wiper blade assembly, and a connector member is coupled to the clamp. In a state where the connector member is coupled to the clamp, the wiper arm is coupled to the connector member.

Wiper blade assemblies are broadly classified into three types according to the way a blade closely attached to the surface of a windshield to wipe off dirt is supported.

The first type is a tournament-type wiper in which multi-stage levers are provided, and a blade is supported by ends of each lever.

The tournament-type wiper is the oldest form of wiper assembly. A wiper strip coupled to a linear support member is bent by a plurality of tournament levers to follow the curvature of the vehicle glass. The tournament-type wiper assembly has superior durability since the tournament levers form a stable support point and shows good wiping performance since it can properly follow the curvature of the glass.

However, when a vehicle is driven at high speed, the tournament-type wiper assembly is pulled away from the glass surface of the vehicle by the pressure of air acting on the glass surface. Accordingly, the wiping performance of the tournament-type wiper assembly deteriorates.

To solve this problem, a spoiler member is additionally attached onto each of the tournament levers. In this case, however, since the spoiler member should be additionally manufactured and assembled, the manufacturing costs and weight of parts increase. Also, the addition of the spoiler member impairs the appearance of the vehicle.

The second type is a flat plate-type wiper in which a blade is coupled to and thus supported by a support rail or body spring having a predetermined curvature and elasticity.

The flat plate-type wiper has a low height, is formed integrally with the blade, and has simple appearance.

However, since a windshield has a different curvature according to the vehicle model, it is difficult to perfectly wipe the entire area of the windshield no matter how excellent the elasticity of the body spring is. In addition, when the wiper moves to a point with a different curvature, ends of the wiper may fail to follow the curvature of the windshield, that is, may lift off the surface of the windshield.

To address these problems, a uniblade-type wiper, which is the third type, has been suggested. In the uniblade-type wiper, a flat plate-type wiper is reinforced and supported by a tournament structure.

That is, in a uniblade-type wiper assembly, two tournament levers are installed only in the middle of a tournament wiper strip, and the tournament levers are covered with a cover having a spoiler function and then coupled to the cover.

However, since both ends of the wiper strip are not properly supported in the uniblade-type wiper assembly, the uniblade-type wiper assembly cannot properly follow the curvature of glass.

Accordingly, in order to solve the defects as described above, the applicant filed an application relating to a wide blade assembly, Korean Patent Laid-Open Publication No. 10-2014-0000779.

That is, in the Korean Patent Laid-Open Publication, support portions for preventing the movement of a secondary lever are formed on an inner surface of a spoiler portion of a primary lever. The support portions support the secondary lever to prevent the secondary lever from moving on the inner surface of the spoiler portion of the primary lever when a wiper is or is not in operation. In addition, both ends of a wiper strip connected to the secondary lever may be supported properly to enable the wiper to better follow the curvature of glass, thereby improving the wiping performance of the wiper.

The applicant may intend to improve the Korean Patent Laid-Open Publication to provide a wiper blade assembly able to better follow the curvature of glass.

### SUMMARY

An aspect of the present invention may provide a wiper blade assembly able to better follow the curvature of glass in both ends of a contact member.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, a wiper blade assembly may include a primary lever; a secondary lever disposed to be adjacent to the primary lever; a secondary lever connecting structure coupled to the secondary lever; and a yoke member hinge-coupled to the secondary lever connecting structure, wherein the yoke member includes a claw portion, the claw portion being moved apart from the secondary lever.

In addition, in the wiper blade assembly according to an aspect of the present invention, the secondary lever may include a first secondary lever disposed at one end of the primary lever and a second secondary lever disposed at the other end of the primary lever, the secondary lever connecting structure may include a first secondary lever connecting structure coupled to the first secondary lever and a second secondary lever connecting structure coupled to the second secondary lever, and the yoke member may include a first yoke member hinge-coupled to the first secondary lever connecting structure and a second yoke member hinge-coupled to the second secondary lever connecting structure.

Moreover, in the wiper blade assembly according to an aspect of the present invention, the first yoke member may include a first claw portion disposed on one end of the first yoke member and another first claw portion disposed on the other end of the first yoke member, and the second yoke member may include a second claw portion disposed on one end of the second yoke member and another second claw portion disposed on the other end of the second yoke member.

Furthermore, in the wiper blade assembly according to an aspect of the present invention, the first secondary lever connecting structure may include a first reference hinge portion disposed in a certain region of one end portion thereof and a third claw portion disposed in a certain region of the other end portion thereof, and the second secondary lever connecting structure may include a second reference hinge portion disposed in a certain region of one end portion thereof and a fourth claw portion disposed in a certain region of the other end portion thereof.

Moreover, in the wiper blade assembly according to an aspect of the present invention, the first yoke member may further include a first hinge hole and the second yoke member may further include a second hinge hole, wherein the first hinge hole is hinge-coupled to the first reference hinge portion and the second hinge hole is hinge-coupled to the second reference hinge portion.

Furthermore, in the wiper blade assembly according to an aspect of the present invention, the first secondary lever connecting structure may further include a third hinge hole positioned between the first reference hinge portion and the third claw portion and hinge-coupled to one end portion of the primary lever. The second secondary lever connecting structure may further include a fourth hinge hole positioned between the second reference hinge portion and the fourth claw portion and hinge-coupled to the other end portion of the primary lever.

Further, the wiper blade assembly according to an aspect of the present invention may further include: a contact member coupled to the yoke members and the secondary lever connecting structures, the contact member being coupled to the first claw portion disposed on one end of the first yoke member and the first claw portion disposed on the other end of the first yoke member, the third claw portion, the fourth claw portion, and the second claw portion disposed on one end of the second yoke member and the second claw portion disposed on the other end of the second yoke member.

Furthermore, the wiper blade assembly according to an aspect of the present invention may further include: a primary lever groove disposed in a certain region of a top end portion of the primary lever and a secondary lever groove disposed in a certain region of a top end portion of the secondary lever.

In addition, in the wiper blade assembly according to an aspect of the present invention, the primary lever may include a first projection disposed on one side of a certain region of the primary lever and allowing a cap portion to be hinge-coupled to the first projection and a second projection disposed on the other side of the certain region of the primary lever and allowing the cap portion to be hinge-coupled to the second projection, the cap portion being hinge-coupled to the first projection or the second projection.

In addition, in the wiper blade assembly according to an aspect of the present invention, the secondary lever connecting structure is completely fixed to the secondary lever to be integrally formed therewith.

Furthermore, the wiper blade assembly according to an aspect of the present invention may further include: a stopper portion disposed in a certain region of an interior portion of the secondary lever and a hole disposed in a certain region of the secondary lever connecting structure, the stopper portion being inserted into and fixed to the hole.

### BRIEF DESCRIPTION OF DRAWINGS

FIG. 1a is a coupled perspective view of a wiper blade assembly according to the present invention; FIG. 1b is an exploded perspective view of the wiper blade assembly according to the present invention; and FIG. 1c is a cut-away perspective view taken along line I-I of FIG. 1a.

FIG. 2 is a partial bottom view of a primary lever according to the present invention.

FIG. 3 is a schematic cross-sectional view illustrating connection relationships among the primary lever, a secondary lever, a secondary lever connecting structure, and a yoke member.

FIG. 4a and FIG. 4b are schematic views illustrating hinge-coupling of the primary lever and the secondary lever connecting structure according to the present invention.

FIG. 5a and FIG. 5b are views illustrating a state in which the secondary lever and the secondary lever connecting structure are coupled to each other.

FIG. 6a and FIG. 6b are views illustrating pivoting of the yoke member and the secondary lever connecting structure.

FIG. 7a and FIG. 7b are views illustrating pivoting of the yoke member and the secondary lever.

FIG. 8a and FIG. 8b are schematic perspective views illustrating a coupling state between the secondary lever connecting structure and the secondary lever.

FIG. 9 is a partial perspective view illustrating a common use of the wiper blade assembly according to the present invention.

### DETAILED DESCRIPTION

Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

The present invention will now be described more fully with reference to the accompanying drawings, in which exemplary embodiments of the invention are shown. Like reference numerals refer to like elements throughout the specification. As used herein, the term “and/or” includes any and all combinations of one or more of the associated listed items.

It will be understood that, although the terms first, second, third, etc., may be used herein to describe various elements, these elements should not be limited by these terms. These terms are only used to distinguish one element from another element. Thus, a first element discussed below could be termed a second element without departing from the teachings of the present invention.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprises” and/or “comprising,” when used in this specification, specify the presence of stated elements, but do not preclude the presence or addition of one or more other elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Spatially relative terms, such as “below”, “beneath”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” other elements or features would then be oriented “above” the other elements or features. Thus, the exemplary term “below” or “beneath” can encompass both an orientation of above and below. The device may be otherwise oriented and the spatially relative descriptors used herein interpreted accordingly.

Hereinafter, exemplary embodiments of the present invention will be described in detail with reference to the attached drawings.

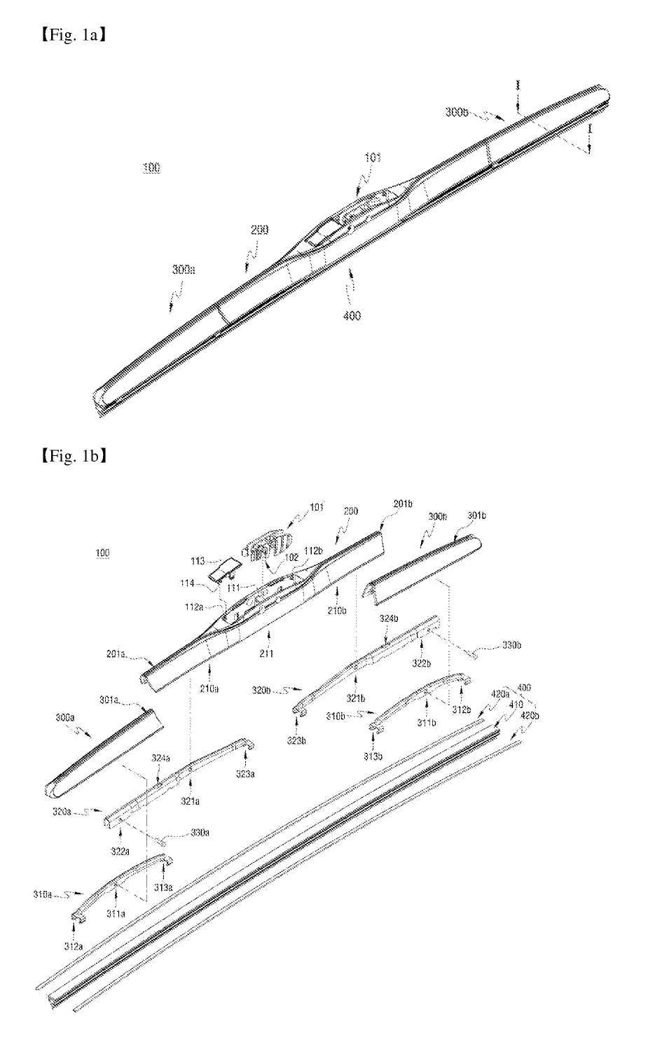

FIG. 1a is a coupled perspective view of a wiper blade assembly according to the present invention; FIG. 1b is an exploded perspective view of the wiper blade assembly according to the present invention; and FIG. 1c is a cut-away perspective view taken along line I-I of FIG. 1a.

First, referring to FIG. 1a and FIG. 1b, a wiper blade assembly 100 according to the present invention may include a primary lever 200, secondary levers 300a and 300b disposed to be adjacent to the primary lever 200, secondary lever connecting structures 320a and 320b coupled to the secondary levers 300a and 300b, yoke members 310a and 310b hinge-coupled to the secondary lever connecting structures 320a and 320b, and a contact member 400 coupled to the yoke members.

More specifically, the secondary levers 300a and 300b may include a first secondary lever 300a disposed at one end of the primary lever 200 and a second secondary lever 300 disposed at the other end of the primary lever 200, and the secondary lever connecting structures 320a and 320b may include a first secondary lever connecting structure 320a coupled to the first secondary lever and a second secondary lever connecting structure 320b coupled to the second secondary lever.

In addition, the yoke members 310a and 310b may include a first yoke member 310a hinge-coupled to the first secondary lever connecting structure 320a and a second yoke member 310b hinge-coupled to the second secondary lever connecting structure 320b.

In this case, the first yoke member 310a and the second yoke member 310b may include hinge holes 311a and 311b hinge-coupled to the first and second secondary lever connecting structures 320a and 320b, respectively.

More specifically, the first yoke member 310a may include a first hinge hole 311a and the second yoke member 310b may include a second hinge hole 311b, and the respective yoke members may be hinge-coupled to the secondary lever connecting structures 320a and 320b.

In addition, the yoke members 310a and 310b slidably support the contact member.

The first yoke member 310a may include first claw portions 312a and 313a at both ends thereof, respectively. The second yoke member 310b may include second claw portions 312b and 313b at both ends thereof, respectively.

More specifically, the first claw portions 312a and 313a may include a first claw portion 312a disposed on one end of the first yoke member 310a and another first claw portion 313a disposed on the other end of the first yoke member 310a.

In addition, the second claw portions 312b and 313b may include a second claw portion 312b disposed on one end of the second yoke member 310b and another second claw portion 313b disposed on the other end of the second yoke member 310b.

Here, the yoke members 310a and 310b may be identical to yokes used in a conventional tournament-type wiper assembly. Therefore, the shape and structure of the yoke members are not limited to those illustrated in the present invention.

Meanwhile, as described above, the secondary lever connecting structures 320a and 320b may include the first secondary lever connecting structure 320a coupled to the first secondary lever and the second secondary lever connecting structure 320b coupled to the second secondary lever.

In this case, the first secondary lever connecting structure 320a may include a first reference hinge portion 322a disposed in a certain region of one end portion thereof and a third claw portion 323a disposed in a certain region of the other end portion thereof. The first secondary lever connecting structure 320a may include a third hinge hole 321a positioned between the first reference hinge portion 322a and the third claw portion 323a and hinge-coupled to one end portion of the primary lever 200.

In addition, the second secondary lever connecting structure 320b may include a second reference hinge portion 322b disposed in a certain region of one end portion thereof and a fourth claw portion 323b disposed in a certain region of the other end portion thereof. The second secondary lever connecting structure 320b may include a fourth hinge hole 321b positioned between the second reference hinge portion 322b and the fourth claw portion 323b and hinge-coupled to the other end portion of the primary lever 200.

Continuously referring to FIG. 1a and FIG. 1b, the wiper blade assembly 100 according to the present invention may include the contact member 400 coupled to the yoke members and the secondary lever connecting structures.

More specifically, as described above, the yoke members 310a and 310b slidably support the contact member. The first yoke member 310a may include the first claw portions 312a and 313a at the both ends thereof, respectively. The second yoke member 310b may include the second claw portions 312b and 313b at the both ends thereof, respectively.

That is, the first claw portions 312a and 313a may include the first claw portion 312a disposed on one end of the first yoke member 310a and the first claw portion 313a disposed on the other end of the first yoke member 310a. In addition, the second claw portions 312b and 313b may include the second claw portion 312b disposed on one end of the second yoke member 310b and the second claw portion 313b disposed on the other end of the second yoke member 310b.

In addition, the secondary lever connecting structures 320a and 320b may include the first secondary lever connecting structure 320a coupled to the first secondary lever and the second secondary lever connecting structure 320b coupled to the second secondary lever.

In this case, the first secondary lever connecting structure 320a may include the third claw portion 323a disposed in the certain region of the other end portion thereof, and the second secondary lever connecting structure 320b may include the fourth claw portion 323b disposed in the certain region of the other end portion thereof.

In the present invention, the coupling of the contact member to the yoke members and the secondary lever connecting structures means that the contact member is coupled to the first claw portion 312a, the first claw portion 313a, the third claw portion 323a, the fourth claw portion 323b, the second claw portion 312b, and the second claw portion 313b.

Meanwhile, the contact member 400 may include a wiper strip 410 and support members 420a and 420b supporting the wiper strip 410.

The wiper strip 410 is typically made of a rubber material. The wiper strip 410 may include grooves (no reference numerals given) in both sides thereof to be coupled to the support members 420a and 420b.

The support members 420a and 420b are typically elastic and support the wiper strip 410. The support members 420a and 420b may be inserted into and coupled to the grooves formed in the both sides of the wiper strip 410. In the drawings, two separate support members, i.e., a first support member 420a and a second support member 420b are illustrated. However, the wiper strip 410 may also be supported by a single support member.

Meanwhile, in the present invention, the contact member 400 may be modified according to the need of a user. Therefore, a shape and a structure of the contact member 400 are not limited to those illustrated in the present invention.

Continuously referring to FIG. 1a and FIG. 1b, the primary lever 200 of the wiper blade assembly 100 according to the present invention may include a first spoiler portion 210a hinge-coupled to the first secondary lever connecting structure 320a, on one end thereof and a second spoiler portion 210b hinge-coupled to the second secondary lever connecting structure 320b, on the other end thereof.

In addition, referring to FIG. 1a and FIG. 1b, the wiper blade assembly 100 according to the present invention may include a connector 101 coupled to a certain region 211 of the primary lever 200 and connected to a wiper arm, and may also include a connecting pin 111 to which the connector is coupled.

The connector 101 is generally called a wiper arm connector. The connector 101 may be accommodated in the certain region of the primary lever and may be connected to the wiper arm (not shown) having a U-shaped hook at an end thereof.

In this case, the connector 101 may include a pinhole 102 coupled to the connecting pin 111. The pinhole 102 may be inserted into or removed from the connecting pin 111 by interference fitting.

In addition, the wiper blade assembly 100 according to the present invention may include a cap portion 113 installed to be hinge-opened or closed, in the certain region 211 of the primary lever 200.

In this case, the primary lever 200 may include a first projection 112a to which the cap portion 113 is hinge-coupled, on one side of the certain region 211 thereof, and may include a second projection 112b to which the cap portion 113 is hinge-coupled, on the other side of the certain region 211 thereof.

That is, the cap portion 113 may be hinge-coupled to the first projection 112a or may be hinge-coupled to the second projection 112b.

FIG. 9 is a partial perspective view illustrating a common use of the wiper blade assembly according to the present invention.

That is, unlike FIG. 1b, FIG. 9 illustrates a case in which a cap portion 113′ is hinge-coupled to the second projection 112b.

In general, the wiper arm is connected to a driving shaft connected to a wiper driving motor on a vehicle side, and the wiper blade assembly may be driven by the driving of the wiper arm.

In the driving of the wiper arm, a position of the driving shaft of the wiper arm may be varied depending on whether a vehicle is an LH vehicle (vehicle in which a driver is positioned on the left side thereof) or an RH vehicle (vehicle in which a driver is positioned on the right side thereof).

Thus, a position in which the cap portion 113 is hinge-coupled to the first projection 112a or is hinge-coupled to the second projection 112b may be determined on whether a vehicle is an LH vehicle or an RH vehicle.

That is, in the present invention, assuming that for example, the cap portion 113 is hinge-coupled to the first projection 112a in the LH vehicle, since the cap portion 113 may be hinge-coupled to the second projection 112b in the RH vehicle, a wide blade assembly applicable to both the LH vehicle and the RH vehicle in common may be provided.

In this case, reference numerals 114 and 114′ of FIG. 1b and FIG. 9, which have not been yet explained, correspond to a coupling portion of the cap portion. The cap portion 113 may be hinge-coupled to the first projection 112a or the second projection 112b by the coupling portion thereof.

The connector according to the present invention may be employed or replaced according to a type of the wiper arm. Therefore, a shape and a structure of the connector are not limited to those illustrated in the present invention.

Further, referring to FIG. 1a through FIG. 1c, as described above, the wiper blade assembly 100 according to the present invention may include the primary lever 200 and the secondary levers 300a and 300b disposed to be adjacent to the primary lever 200. The secondary levers 300a and 300b may include a first secondary lever 300a disposed at one end of the primary lever 200 and a second secondary lever 300 disposed at the other end of the primary lever 200.

In this case, the primary lever and the secondary levers may include longitudinal grooves disposed in certain regions of top end portions thereof. More specifically, the primary lever 200 may include primary lever grooves 201a and 201b disposed in certain regions of a top end portion thereof, and the first secondary lever 300a and the second secondary lever 300b may include secondary lever grooves 301a and 301b disposed in certain regions of the respective top end portions thereof.

The primary lever grooves 201a and 201b and the secondary lever grooves 301a and 301b may generate a vortex to the wind applied to the wiper blade assembly, in regions of the primary lever grooves 201a and 201b and the secondary lever grooves 301a and 301b.

The generated vortex may provide a degree of pressure allowing the wiper blade assembly to be adhered to a window surface, whereby adhesion properties of the wiper blade assembly may be improved.

Meanwhile, reference numerals 330a and 330b, which have not been yet explained, correspond to a first coupling member and a second coupling member, respectively. As described later, these coupling members may be inserted into the reference hinge portions disposed in certain regions of respective one end portions of the secondary lever connecting structures, and may enable the secondary lever connecting structures and the yoke members to be hinge-coupled to each other.

Hereinafter, a configuration of the wiper blade assembly 100 according to the present invention will be described in detail.

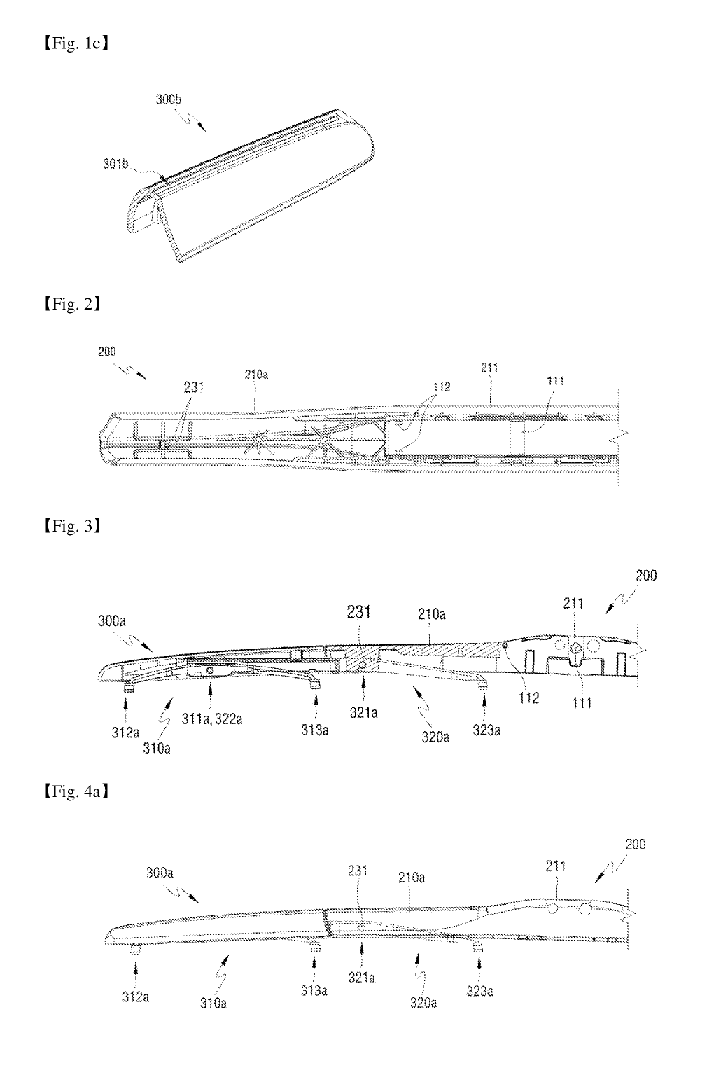

FIG. 2 is a partial bottom view of a primary lever according to the present invention.

Referring to FIG. 2, as described above, the primary lever 200 may include the first spoiler portion 210a hinge-coupled to the first secondary lever connecting structure (not shown), on one end thereof.

In this case, the first spoiler portion 210a may include a hinge axis portion 231 in a certain region of one end portion thereof, and the first secondary lever connecting structure (not shown) may be hinge-coupled to the hinge axis portion 231.

That is, in FIG. 1b described above, the first secondary lever connecting structure 320a may include the first reference hinge portion 322a disposed in a certain region of one end portion thereof and the third claw portion 323a disposed in a certain region of the other end portion thereof. The first secondary lever connecting structure 320a may include the third hinge hole 321a positioned between the first reference hinge portion 322a and the third claw portion 323a and hinge-coupled to one end portion of the primary lever 200.

In this case, the hinge axis portion 231 may be coupled to the third hinge hole 321a.

That is, in the present invention, the hinge axis portion 231 disposed in the first spoiler portion 210a and the third hinge hole 321a of the first secondary lever connecting structure 320a may be hinge-coupled to each other, such that the first spoiler portion 210a and the first secondary lever connecting structure 320a may be hinge-coupled to each other.

Meanwhile, although not illustrated in the drawings, the second spoiler portion may include the hinge axis portion, such that the second spoiler portion and the second secondary lever connecting structure may be hinge-coupled to each other.

FIG. 3 is a schematic cross-sectional view illustrating connection relationships among the primary lever, the secondary lever, the secondary lever connecting structure, and the yoke member.

That is, connection relationships among the primary lever, the secondary lever, the secondary lever connecting structure, and the yoke member in FIG. 3 are as follows. However, hereinafter, connection relationships among the first secondary lever, the first secondary lever connecting structure, and the first yoke member will be explained, which may be identical to connection relationships among the second secondary lever, the second secondary lever connecting structure, and the second yoke member.

First, as described above, the primary lever 200 may include the first spoiler portion 210a hinge-coupled to the first secondary lever connecting structure 320a, on one end thereof.

The secondary levers 300a and 300b may include the first secondary lever 300a disposed at one end of the primary lever 200, and the secondary lever connecting structures 320a and 320b may include the first secondary lever connecting structure 320a coupled to the first secondary lever.

In addition, the yoke members may include the first yoke member 310a hinge-coupled to the first secondary lever connecting structure 320a, and the first yoke member 310a may include the first hinge hole 311a.

In addition, the first secondary lever connecting structure 320a may include the first reference hinge portion 322a disposed in a certain region of one end portion thereof.

In this case, in a state in which the first hinge hole 311a and the first reference hinge portion 322a are arranged, the first coupling member 330a may be inserted into the first hinge hole 311a and the first reference hinge portion 322a, whereby the first yoke member 310a may be hinge-coupled to the first secondary lever connecting structure 320a.

Meanwhile, in a state in which the first yoke member 310a is hinge-coupled to the first secondary lever connecting structure 320a by the first coupling member 330a, the first secondary lever connecting structure 320a may be coupled to the first secondary lever 300a.

FIG. 5a and FIG. 5b are views illustrating a state in which the secondary lever and the secondary lever connecting structure are coupled to each other. As illustrated in FIG. 5a and FIG. 5b, the first secondary lever connecting structure 320a may be inserted into the first secondary lever 300a by interference fitting, such that the first secondary lever connecting structure 320a may be fixed to the first secondary lever 300a.

In this case, in the present invention, the first secondary lever connecting structure 320a may be completely fixed to the first secondary lever 300a to be integrally formed therewith.

This is to stably couple the first secondary lever connecting structure 320a and the first secondary lever 300a together. Due to the stable coupling therebetween, a phenomenon in which the first secondary lever connecting structure 320a is separated or moved apart from the first secondary lever 300a may be prevented.

Meanwhile, in the present invention, to prevent the first secondary lever connecting structure 320a from being separated or moved apart from the first secondary lever 300a, the following configuration may be further included.

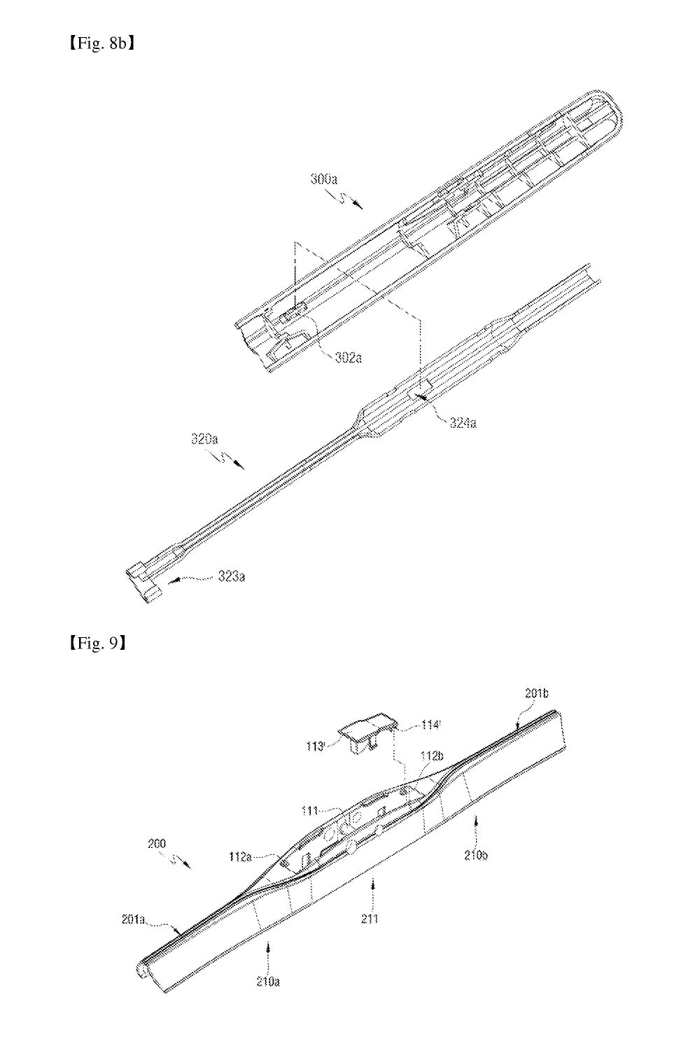

FIG. 8a and FIG. 8b are schematic perspective views illustrating a coupling state between the secondary lever connecting structure and the secondary lever.

As illustrated in FIG. 8a and FIG. 8b, the first secondary lever 300a may include a stopper portion 302a in a certain region of the interior thereof, and the first secondary lever connecting structure 320a may include a hole 324 in a certain region thereof.

That is, in fixing the first secondary lever connecting structure 320a to the first secondary lever 300a, the stopper portion 302a may be inserted into and fixed to the hole 324a. By the fixation, a phenomenon in which the first secondary lever connecting structure 320a is separated or moved apart from the first secondary lever 300a in an X-direction shown in FIG. 8a may be prevented.

Meanwhile, even in the case that the first secondary lever connecting structure 320a is fixed to the first secondary lever 300a, since the first yoke member 310a is hinge-coupled to the first secondary lever connecting structure 320a by the first coupling member 330a, the first yoke member 310a may pivot on the first reference hinge portion.

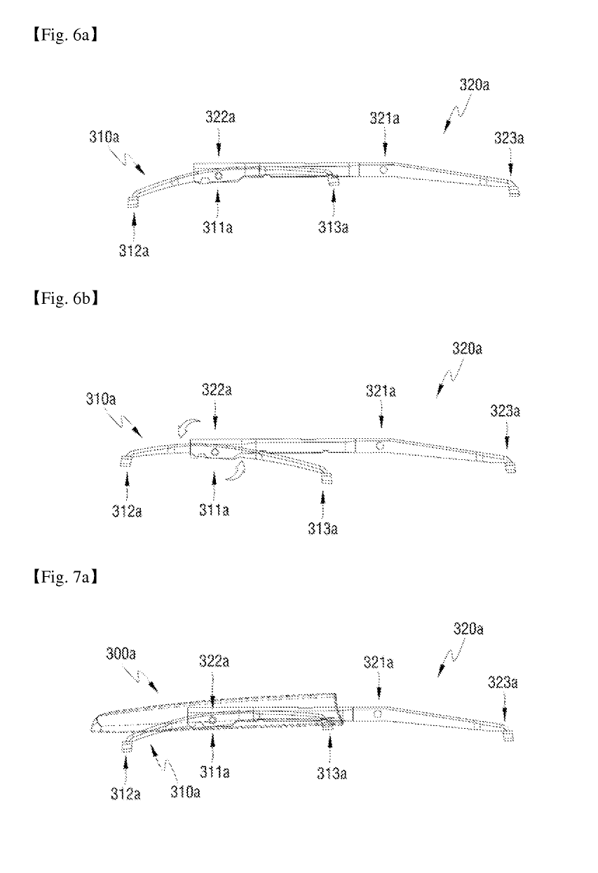

FIG. 6a and FIG. 6b are views illustrating pivoting of the yoke member and the secondary lever connecting structure.

As illustrated in FIG. 6a and FIG. 6b, the first yoke member 310a may pivot on the first reference hinge portion 322a.

As described above, the first yoke member 310a may include the first claw portions 312a and 313a at the both ends thereof, respectively. That is, the first claw portions 312a and 313a may include the first claw portion 312a disposed on one end of the first yoke member 310a and the first claw portion 313a disposed on the other end of the first yoke member 310a.

In this case, the contact member according to the present invention may be coupled to the first claw portion 312a disposed on one end of the first yoke member 310a and the first claw portion 313a disposed on the other end of the first yoke member 310.

That is, in the present invention, the pivoting of the first yoke member 310a on the first reference hinge portion 322a means that the first claw portion 312a and the first claw portion 313a are pivotally rotatable and consecutively, means improvements in the property of following the curvature of glass in the contact member to which the first claw portion 312a and the first claw portion 313a are coupled.

This may have significant effects on the first claw portion 312a coupled to one end of the contact member. As can be seen in FIG. 3a through FIG. 3c of Korean Patent Laid-Open Publication No. 10-2014-0000779, in general, the claw portions coupled to both ends of the contact member may be integrally formed with the secondary levers.

In addition, since the secondary levers may be formed of a hard material, it may be difficult to improve the property of following the curvature of glass in the ends of the contact member.

However, the first claw portion 312a coupled to one end of the contact member may pivot on the first reference hinge portion 322a, thereby allowing for improvements in the property of following the curvature of glass in the ends of the contact member in the present invention.

The characteristics of the present invention can be explained as follows.

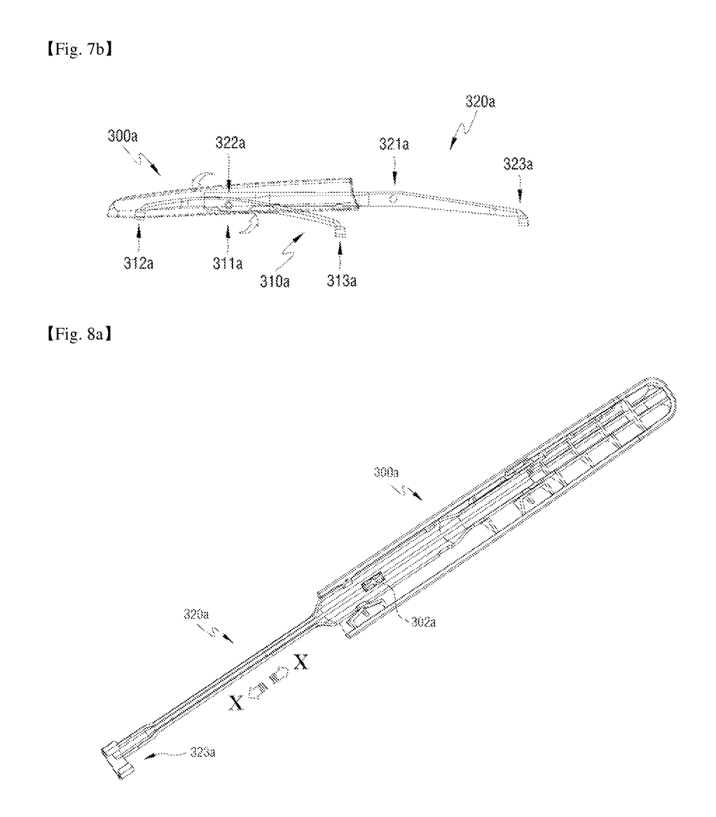

FIG. 7a and FIG. 7b are views illustrating pivoting of the yoke member and the secondary lever.

Referring to FIG. 7a and FIG. 7b, as described above, in general, since the claw portions coupled to the both ends of the contact member are integrally formed with the secondary levers, the claw portions coupled to the both ends of the contact member may be constrained by movement of the secondary levers.

However, in the present invention, the claw portions coupled to the both ends of the contact member may be disposed in certain regions of the yoke members, and the yoke member may be moved apart from the secondary levers.

That is, for example, the first claw portion 312a disposed on one end of the first yoke member 310a may be moved apart from the first secondary lever 300a.

Meanwhile, although not illustrated in the drawings, even in the second claw portion 312b disposed on one end of the second yoke member 310b, coupled to the other end of the contact member, the same effects as those in the first claw portion 312a may be generated.

Continuously referring to FIG. 3, in a state in which the first secondary lever connecting structure 320a and the first secondary lever 300a are fixed to each other, the first secondary lever connecting structure 320a may be hinge-coupled to the first spoiler portion 210a.

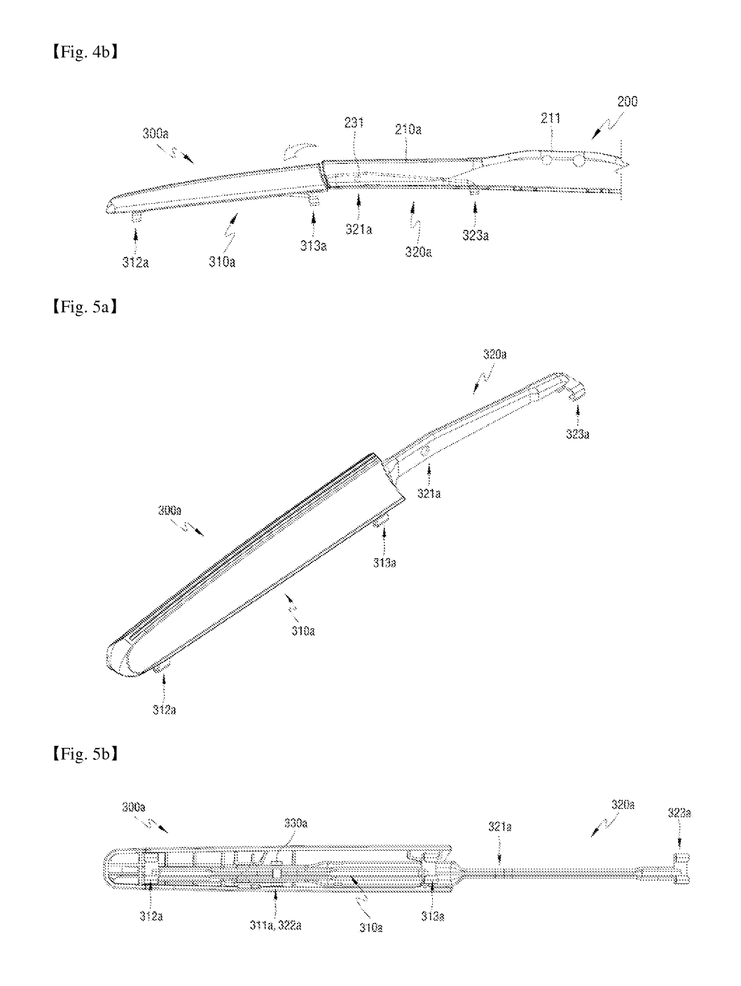

FIG. 4a and FIG. 4b are schematic views illustrating hinge-coupling of the primary lever and the secondary lever connecting structure according to the present invention.

As illustrated in FIG. 4a and FIG. 4b, the first spoiler portion 210a may include the hinge axis portion 231 in a certain region of one end portion thereof, and the third hinge hole 321a of the first secondary lever connecting structure 320a may be hinge-coupled to the hinge axis portion 231.

In addition, as described above, the first secondary lever connecting structure 320a may be coupled to the first secondary lever 300a to be fixed thereto.

Accordingly, the hinge-coupling of the primary lever and the first secondary lever connecting structure in the present invention may be understood as hinge-coupling of the primary lever and the first secondary lever

That is, as illustrated in FIG. 4a and FIG. 4b, the first secondary lever connecting structure 320a may pivot from the first spoiler portion 210a and consequently, it means that the first secondary lever may pivot from the first spoiler portion 210a.

Thus, in the present invention, by the hinge-coupling of the primary lever and the first secondary lever connecting structure, the first secondary lever connecting structure 320a may improve the property of following the curvature of glass in the contact member coupled to the third claw portion 323a disposed in a certain region of the other end portion thereof.

In addition, since the first secondary lever may pivot from the first spoiler portion 210a by the hinge-coupling of the primary lever and the first secondary lever connecting structure, that is, due to the pivoting of the first secondary lever, the property of following the curvature of glass in the contact member to which the first claw portion 312a disposed on one end of the first yoke member 310a and the first claw portion 313a disposed on the other end of the first yoke member 310a are coupled may be further improved.

As set forth above, according to the present invention, the claw portions coupled to the both ends of the contact member may be disposed in certain regions of the yoke members and the yoke members may be moved apart from the secondary levers, such that the claw portions may be moved apart from the secondary levers to allow for improvements in the property of following the curvature of glass, thereby wiping performance of the wiper.

While exemplary embodiments have been shown and described above, it will be apparent to those skilled in the art that modifications and variations could be made without departing from the spirit and scope of the present invention as defined by the appended claims.

What is claimed is:

1. A wiper blade assembly comprising:
a primary lever;
a secondary lever disposed to be adjacent to the primary lever;
a secondary lever connecting structure coupled to the secondary lever; and
a yoke member hinge-coupled to the secondary lever connecting structure,
wherein the yoke member includes a claw portion, the claw portion being moved apart from the secondary lever.

2. The wiper blade assembly of claim 1, wherein the secondary lever includes a first secondary lever disposed at one end of the primary lever and a second secondary lever disposed at the other end of the primary lever,
the secondary lever connecting structure includes a first secondary lever connecting structure coupled to the first secondary lever and a second secondary lever connecting structure coupled to the second secondary lever, and
the yoke member includes a first yoke member hinge-coupled to the first secondary lever connecting structure and a second yoke member hinge-coupled to the second secondary lever connecting structure.

3. The wiper blade assembly of claim 2, wherein the first yoke member includes a first claw portion disposed on one end of the first yoke member and another first claw portion disposed on the other end of the first yoke member, and
the second yoke member includes a second claw portion disposed on one end of the second yoke member and another second claw portion disposed on the other end of the second yoke member.

4. The wiper blade assembly of claim 3, wherein the first secondary lever connecting structure includes a first reference hinge portion disposed in a certain region of one end portion thereof and a third claw portion disposed in a certain region of the other end portion thereof, and
the second secondary lever connecting structure includes a second reference hinge portion disposed in a certain region of one end portion thereof and a fourth claw portion disposed in a certain region of the other end portion thereof.

5. The wiper blade assembly of claim 1, further comprising: a primary lever groove disposed in a certain region of a top end portion of the primary lever and a secondary lever groove disposed in a certain region of a top end portion of the secondary lever.

6. The wiper blade assembly of claim 1, wherein the primary lever includes a first projection disposed on one side of a certain region of the primary lever and allowing a cap portion to be hinge-coupled to the first projection and a second projection disposed on the other side of the certain region of the primary lever and allowing the cap portion to be hinge-coupled to the second projection,
the cap portion being hinge-coupled to the first projection or the second projection.

7. The wiper blade assembly of claim 1, wherein the secondary lever connecting structure is completely fixed to the secondary lever to be integrally formed therewith.

8. The wiper blade assembly of claim 7, further comprising: a stopper portion disposed in a certain region of an interior portion of the secondary lever and a hole disposed in a certain region of the secondary lever connecting structure,
the stopper portion being inserted into and fixed to the hole.
